(19) United States
(12) Patent Application Publication
(10) Pub. No.: US 2018/0108914 A1
(43) Pub. Date: Apr. 19, 2018

(54) ELECTRODE FOR LITHIUM BATTERY, LITHIUM BATTERY INCLUDING THE SAME, AND METHOD OF MANUFACTURING THE LITHIUM BATTERY

(71) Applicant: SAMSUNG SDI CO., LTD., Yongin-si (KR)

(72) Inventors: Ilwon SEONG, Yongin-si (KR); Seungho NA, Yongin-si (KR); Seojae LEE, Yongin-si (KR); Jaeyeon LEE, Yongin-si (KR); Chonghoon LEE, Yongin-si (KR); Kyeongho JANG, Yongin-si (KR); Woonsuk JANG, Yongin-si (KR); Yeonbok JEONG, Yongin-si (KR); Jongwoo CHOI, Yongin-si (KR); Kichul HAM, Yongin-si (KR)

(21) Appl. No.: 15/783,074

(22) Filed: Oct. 13, 2017

(30) Foreign Application Priority Data
Oct. 14, 2016 (KR) 10-2016-0133740

(51) Int. Cl. H01M 4/62; H01M 10/052; H01M 10/04

(52) U.S. Cl. CPC H01M 4/622; H01M 2004/028; H01M 10/04; H01M 10/052

(57) ABSTRACT

An electrode for a lithium battery includes a coating layer on at least one surface of an active material layer. The coating layer includes polymer particles.

### CROSS-REFERENCE TO RELATED APPLICATION

Korean Patent Application No. 10-2016-0133740, filed on Oct. 14, 2016, and entitled, “Electrode for Lithium Battery, Lithium Battery Including the Same, and Method of Manufacturing the Lithium Battery,” is incorporated by reference herein in its entirety.

### BACKGROUND

### 1. Field

One or more embodiments described herein relate to an electrode for a lithium battery, a lithium battery including the electrode, and a method of manufacturing the lithium battery.

### 2. Description of the Related Art

A battery generally includes a positive electrode, a negative electrode, and a separator. The separator may help prevent contact (e.g., an internal short-circuit) between the positive and negative electrodes and may be used as a path for moving electrolyte ions.

During manufacture of a lithium battery, the battery may deform from repeated contractions and expansions of the positive and negative electrodes that occur charging/discharging cycles. This may be caused by improper adherence between one or more of the electrodes and the separator. As a result, battery performance and stability may be adversely affected.

In an attempt to increase the adhesive strength between the separator and one or more of the electrodes, a surface of the separator or the electrodes may be coated with a binder material. However, when the electrodes or separator are coated with a polymer in a gel state, a curing process is needed. This may complicate the manufacturing process and increase costs.

Also, when the separator is coated with a binder material, static generation may be a problem depending on the type of binder material. Static generation may cause a process failure when an electrode assembly including a positive electrode/a separator/a negative electrode are in a rolled configuration.

### SUMMARY

In accordance with one or more embodiments, an electrode for a lithium battery includes an active material layer; and a coating layer on at least one surface of the active material layer, wherein the coating layer includes polymer particles. The coating layer may be filled with the polymer particles. An average particle diameter of the polymer particles may be in a range of about 1 nm to about 10 μm. The polymer particles may include a polymer that is soluble in an organic medium and forms a suspension in an aqueous medium.

The polymer particles may include polyvinylidene fluoride (PVdF), polyvinylidene fluoride-hexafluoropropylene (PVdF-co-HFP), polyvinylidene fluoride-trichlorethylene, polyvinylpyrrolidone, polyethylene oxide (PEO), polyacrylonitrile (PAN), polyamide (PI), polyamic acid (PAA), polyamidimide (PAI), aramid, polyvinylacetate (PVA), an ethylenevinylacetate copolymer, an ethylene ethylacrylate copolymer, polymethylmethacrylate (PMMA), polyvinylether (PVE), carboxymethylcellulose, polyacrylic acid, polyvinyl alcohol, or a combination thereof. The polymer particles may include polyvinylidene fluoride (PVdF), polyvinylidene fluoride-hexafluoropropylene (PVdF-co-HFP), polyvinylidene fluoride-trichlorethylene, or a combination thereof.

The coating layer may have a density in a range of about 200 mg/cc to about 2000 mg/cc. The coating layer may have a thickness in a range of about 0.1 μm to about 10 μm. The active material layer may have a thickness in a range of about 1 μm to about 300 μm. The electrode may exhibit an electrostatic charge of lower than 0.1 kV/in.

In accordance with one or more other embodiments, a lithium battery includes a positive electrode; a negative electrode; and a separator between the positive electrode and the negative electrode, wherein at least one of the positive electrode and the negative electrode includes the electrode as previously described. At least the positive electrode may be an electrode for a lithium battery. The electrode may be arranged such that the coating layer contacts the separator.

In accordance with one or more other embodiments, a method for manufacturing a lithium battery includes preparing a suspension including polymer particles in an aqueous medium; applying the suspension on at least one of a positive electrode active material layer and a negative electrode active material layer; and disposing the separator between the positive electrode active material layer and the negative electrode active material layer and high-temperature compressing the separator.

The polymer particles may include polyvinylidene fluoride (PVdF), polyvinylidene fluoride-hexafluoropropylene (PVdF-co-HFP), polyvinylidene fluoride-trichlorethylene, polyvinylpyrrolidone, polyethylene oxide (PEO), polyacrylonitrile (PAN), polyamide (PI), polyamic acid (PAA), polyamidimide (PAI), aramid, polyvinylacetate (PVA), an ethylene vinylacetate copolymer, an ethylene ethylacrylate copolymer, polymethylmethacrylate (PMMA), polyvinylether (PVE), carboxymethylcellulose, polyacrylic acid, polyvinyl alcohol, or a combination thereof. The polymer particles may include polyvinylidene fluoride (PVdF), polyvinylidene fluoride-hexafluoropropylene (PVdF-co-HFP), polyvinylidene fluoride-trichlorethylene, or a combination thereof.

The polymer particles may have an average particle diameter in a range of about 1 nm to about 10 μm. The suspension may have a viscosity in a range of about 10 cps to about 1000 cps. The high-temperature compressing may be performed at a temperature in a range of about 70° C. to about 150° C. The high-temperature compressing may be performed at a pressure in a range of about 300 kgf to about 1000 kgf.

### BRIEF DESCRIPTION OF THE DRAWINGS

Features will become apparent to those of skill in the art by describing in detail exemplary embodiments with reference to the attached drawings in which:

FIG. 1 illustrates an embodiment of an electrode;

FIG. 2 illustrates an embodiment of a lithium battery;

FIG. 3 illustrates another embodiment of a lithium battery;

FIG. 4 illustrates another embodiment of a lithium battery;

FIG. 5A illustrates an example of a scanning electron microscope (SEM) image of a surface of a coating layer, and FIG. 5B illustrates an SEM image that shows a part where a positive electrode and a coating layer contact each other;

FIG. 6 illustrates another example of an SEM image that magnifies a part where a positive electrode and a coating layer contact each other;

FIG. 7 illustrates examples of stiffness values of positive electrodes; and

FIG. 8 illustrates examples of changes in discharge capacities per cycle and thicknesses of positive electrodes of lithium batteries.

### DETAILED DESCRIPTION

Example embodiments are described with reference to the drawings; however, they may be embodied in different forms and should not be construed as limited to the embodiments set forth herein. Rather, these embodiments are provided so that this disclosure will be thorough and complete, and will convey exemplary implementations to those skilled in the art. The embodiments (or portions thereof) may be combined to form additional embodiments

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

When an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

According to one or more embodiments, an electrode for a lithium battery may include a coating layer on at least one surface of an active material layer, where the coating layer includes polymer particles. The coating layer may be on at least one surface of the active material layer and, for example, may be coated on a surface of the active material layer which contacts a separator for adhesion between the active material layer and the separator.

The polymer particles in the coating layer may include a polymer that is soluble in an organic medium and is capable of forming a suspension in an aqueous medium. In accordance with at least one embodiment, the organic medium may include an organic solvent as a main solvent. For example, the organic medium may include the organic solvent at an amount of at least about 60 vol %, about 70 vol %, about 80 vol %, or about 90 vol %, or may be formed of 100 vol % of an organic solvent. Also, in at least one embodiment, the aqueous medium may include water as a main solvent. For example, the aqueous medium may include water at an amount of at least about 60 vol %, about 70 vol %, about 80 vol %, or about 90 vol %, or may be formed of 100 vol % of water.

Since the polymer particles may form a suspension in which solid fine particles are dispersed in an aqueous medium, the polymer particles may be stacked while maintaining particle form and thus may form a particle filled-type coating layer, even after coating and high-temperature compressing processes performed using a suspension solution including the polymer particles on a surface of the active material layer while the coating layer is formed. When the polymer particles are dissolved in an organic medium and used for the coating process, the particle form disappears and the resultant may undergo a curing process to form a coating layer having a 3-dimensional network structure. Such particle filled-type structure of the coating layer is different from this 3-dimensional network structure.

The coating layer having a particle filled-type structure may easily give adhesive strength between an active material layer and a separator through a high-temperature compressing process. Also, electrostatic generation may significantly decrease when the coating layer is coated on the active material layer, compared to when the same coating layer is coated on the separator. This was confirmed by a test described below.

Examples of polymer particles for forming a suspension in an aqueous medium include polyvinylidene fluoride (PVdF), PVdF-co-HFP, polyvinylidene fluoride-trichlorethylene, polyvinylpyrrolidone, polyethylene oxide (PEO), polyacrylonitrile (PAN), polyamide (PI), polyamic acid (PAA), polyamidimide (PAI), aramid, polyvinylacetate (PVA), an ethylenevinylacetate copolymer, an ethylene ethylacrylate copolymer, polymethylmethacrylate (PMMA), polyvinylether (PVE), carboxymethylcellulose, polyacrylic acid, polyvinyl alcohol, or a combination thereof.

In some embodiments, for example, the polymer particles may include PVdF, PVdF-co-HFP, polyvinylidene fluoride-trichlorethylene, or a combination thereof. These polyvinylidene fluoride-based polymers have advantages of excellent adhesive strength and oxidation resistance between a separator and an electrode. When the polyvinylidene fluoride-based polymers stack on the active material layer in the form of fine particles, electrostatic generation may occur relatively less frequently.

In one embodiment, a binder material that is used to give adhesive strength between active materials, while forming the active material layer and a polymer material that constitutes the polymer particles, may include the same material. When binder types of the coating layer and the active material layer are the same, adhesive strength between the coating layer and the active material layer may be further improved.

In one embodiment, an average particle diameter of the polymer particles may be in a range of about 1 nm to about 10 μm. For example, an average particle diameter of the polymer particles may be in a range of about 1 nm to about 1 μm, about 10 nm to about 100 nm, or about 20 nm to about 50 nm. When the average particle diameter of the polymer particles is within these ranges, the adhesive strength may be sufficient to easily form a suspension having a suitable viscosity in an aqueous solvent. The average particle diameter of the polymer particles may be in a different range in another embodiment.

The density of the coating layer, which has a structure including the polymer particles stacked therein, may be in a range of about 200 mg/cc to about 2000 mg/cc. For example, the density of the coating layer may be in a range of about 400 mg/cc to about 1000 mg/cc. The density of the coating layer may be controlled within these ranges according to a coating method. A coating layer having adhesive strength of a desired level may be formed when the density is within these ranges. The density of the coating layer may be in a different range in another embodiment.

The thickness of the coating layer may be in a range of about 0.1 μm to about 10 μm. For example, a thickness of the coating layer may be in a range of about 200 nm to about 5 μm. For example, a thickness of the coating layer may be in a range of about 200 nm to about 1000 nm. For example, a thickness of the coating layer may be in a range of about 400 nm to about 600 nm. When the thickness of the coating layer is within these ranges, adhesive strength of the coating layer may improve. The thickness of the coating layer may be in a different range in another embodiment.

When the coating layer has a structure in which the polymer particles are stacked and is coated on the active material layer, electrostatic generation may be effectively suppressed. In one embodiment, an electrostatic charge of the electrode for a lithium battery may be lower than 1 kV/in. For example, an electrostatic charge of the electrode for a lithium battery may be lowered to about 0.5 kV/in or lower, about 0.3 kV/in or lower, about 0.1 kV/in or lower, about 0.05 kV/in or lower, or about 0.02 kV/in or lower.

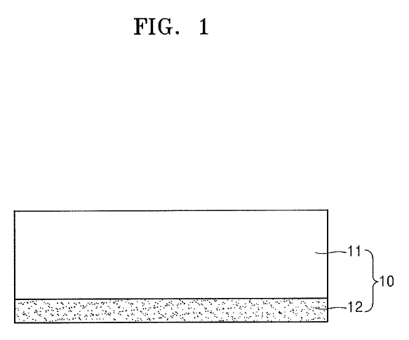

FIG. 1 illustrates a cross-sectional view of an embodiment of an electrode 10, which, for example, may be used for a battery, e.g., lithium battery. The electrode 10 includes a coating layer 12 on one surface of an active material layer 11. The coating layer 12 is on a surface facing a separator in the active material layer 11, and thus may help improve adhesion between the active material layer 11 and the separator. The electrode 10 may be at least one of a positive electrode and a negative electrode of a lithium battery.

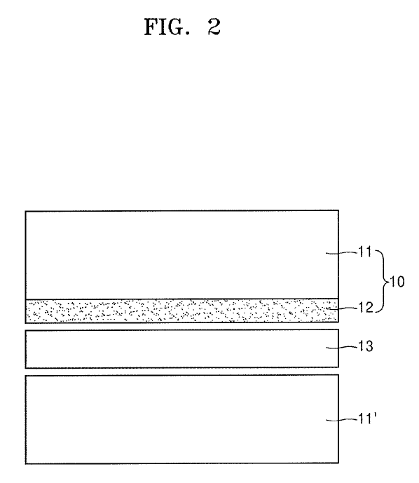

FIG. 2 illustrates an embodiment in which the electrode 10 is applied to the positive electrode or the negative electrode, and the coating layer 12 is only coated on one active material layer 11 among active material layers 11 and 11′. As an example, the electrode 10 for a lithium battery is the positive electrode.

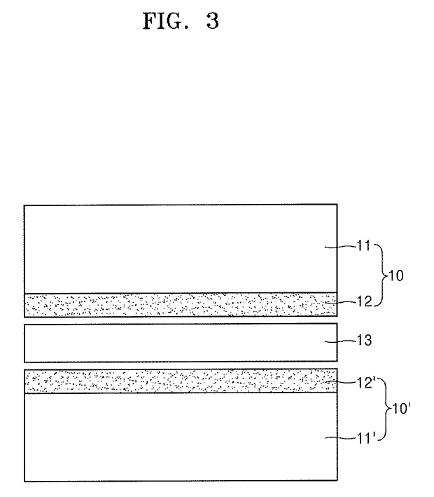

FIG. 3 illustrates an example in which the electrodes 10 and 10′ for a lithium battery are applied to the positive electrode and the negative electrode, respectively, and the coating layers 12 and 12′ are coated on surfaces of the active material layers 11 and 11′ contacting a separator 13.

A method for forming the coating layers 12 and 12′ may include, for example, a coating process that uses a suspension including the polymer particles in an aqueous medium. For example, the suspension may be coated on the active material using flow coating, spin coating, dip coating, bar coating, or another method. After coating the surface of the active material layer with the suspension, a coating layer filled with the polymer particles at a high density may be formed through a high-temperature compressing process. The method for coating the suspension on a surface of the active material layer may be different in another embodiment.

According to one embodiment, a method for preparing a lithium battery may include preparing a suspension including polymer particles in an aqueous medium; applying the suspension on at least one of a positive electrode active material layer and a negative electrode active material layer, and disposing the separator between the positive electrode active material layer and the negative electrode active material layer and high-temperature compressing the separator.

The polymer particles may maintain particle form in the suspension including an aqueous medium by including a polymer that is soluble in an organic medium but insoluble in an aqueous medium. When an organic medium is used, the polymer particles are dissolved in the organic medium and thus may not form a suspension. When a coating solution prepared by dissolving the polymer particles using an organic medium is used, a coating layer of a particle stacking type is not formed, a coating thickness decreases, and adhesive strength between the active material layer and separator may decrease.

Examples of polymer particles of a polymer that is soluble in an organic medium and insoluble in an aqueous medium include PVdF, PVdF-co-HFP, polyvinylidene fluoride-trichlorethylene, polyvinylpyrrolidone, PEO, PAN, PI, polyamic acid (PAA), polyamidimide (PAI), aramid, polyvinylacetate (PVA), an ethylene vinylacetate copolymer, an ethylene ethylacrylate copolymer, PMMA, PVE, carboxymethylcellulose, polyacrylic acid, polyvinyl alcohol, or a combination thereof.

Among these examples of the polymer, polyvinylidene fluoride-based polymers may be used in terms of excellent adhesive strength and oxidation resistance between a separator and an electrode. For example, polymer particles including PVdF, PVdF-co-HFP, polyvinylidene fluoride-trichlorethylene, or a combination thereof may be used.

The average particle diameter of the polymer particles may be in a range of, for example, about 1 nm to about 10 m. For example, an average particle diameter of the polymer particles may be in a range of about 1 nm to about 1 μm, about 10 nm to about 100 nm, or about 20 nm to about 50 nm. The average particle diameter of the polymer particles may be in a different range in another embodiment.

An example of the aqueous medium used in preparation of the suspension includes water. In some embodiments, the aqueous medium may include at least about 60 vol %, about 70 vol %, about 80 vol %, or about 90 vol % of water or may be formed of 100 vol % of water. The aqueous medium may include an organic solvent such as N-methylpyrrolidone (NMP), alcohol, or acetone as mixed in addition to water as long as properties of the aqueous medium are not interfered.

The viscosity of the suspension may be controlled within a range of, for example, about 10 cps to about 1000 cps. When the viscosity is controlled to be within this range, sufficient adhesive strength may be secured between the active material layer and the separator. As a result, active material layers that attach to each other due to excessive stickiness of the coating layer surface may be reduced or prevented.

In another embodiment, a different method for coating the suspension on the active material layer may be used. Examples include flow coating, spin coating, dip coating, and bar coating.

After coating the suspension, drying may optionally be performed to evaporate some of an aqueous medium in the suspension and help formation of a uniform coating layer in the high-temperature compressing later.

The drying may be performed using, for example, hot-air drying or infrared drying, and a drying ratio may result in drying about 30 vol % to about 70 vol % of the aqueous solvent in the suspension. The drying temperature may be determined according to, for example, the type of polymer particles, the type of an aqueous solvent, the atmosphere under which the drying is be performed, and/or one or more other factors. In one embodiment. the drying temperature may be in a range of about 40° C. to about 130° C. When the drying temperature is within this range, the aqueous solvent may be evaporated without excessive contraction of the active material layer. The drying temperature may be in a different range in another embodiment.

After coating the suspension on at least one of the positive electrode active material layer and the negative electrode active material layer, a separator is disposed between the positive electrode active material layer and the negative electrode active material layer, and the resultant is high-temperature compressed.

The high-temperature compressing may densely compress the polymer particles in the suspension, and thus adhesive strength between the active material layer and the separator may be improved. The temperature of the high-temperature compressing may be, for example, in a range of about 70° C. to about 150° C. In one embodiment, the temperature of the high-temperature compressing may be in a range of about 85° C. to about 110° C. For example, the temperature of the high-temperature compressing may be in a range of about 100° C. to about 105° C. When the temperature of the high-temperature compressing is within these ranges, a coating layer having adhesive properties may be formed while maintaining the particle form of the polymer particles. The temperature of the high-temperature compressing may be in a different range in another embodiment.

The pressure of the high-temperature compressing may be, for example, in a range of about 300 kgf to about 1000 kgf. In one embodiment, the pressure of the high-temperature compressing may be in a range of about 450 kgf to about 650 kgf. When the pressure of the high-temperature compressing is within these ranges, a dense coating layer may be formed. The pressure of the high-temperature compressing may be in a different range in another embodiment.

A lithium battery thus prepared includes a separator between a positive electrode and a negative electrode, where at least one of the positive electrode and the negative electrode is an electrode for a lithium battery.

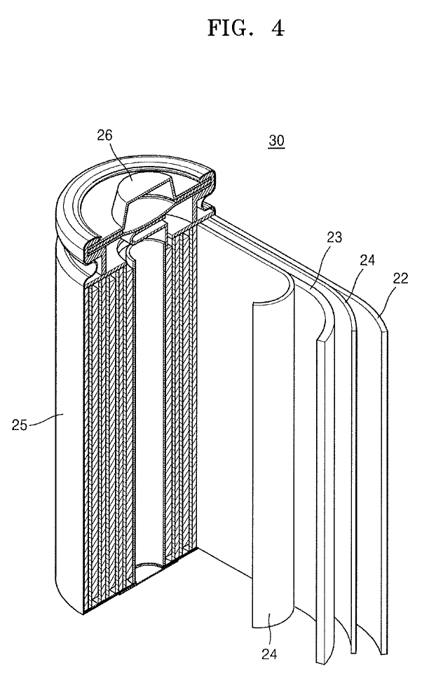

FIG. 4 illustrates an embodiment of a lithium battery 30 which includes a separator 24 between a positive electrode 23 and a negative electrode 22. At least one of the positive electrode 23 and the negative electrode 22 includes the electrode described above. The positive electrode 23, the negative electrode 22, and the separator 24 are wound or folded and then accommodated in a battery case 25. Then, an electrolyte is injected to the battery case 25, and the battery case 25 is sealed by a sealing member 26, thereby completing the manufacture of the lithium battery 30. The battery case 25 may have a shape of a cylinder, a box, a thin film, or another shape. The lithium battery 30 may be a lithium ion battery.

The positive electrode 23 includes a positive electrode current collector and a positive electrode active material layer on the positive electrode current collector.

The positive electrode current collector may be prepared to have a thickness in a range of, for example, about 3 micrometers (μm) to about 500 μm. The positive electrode current collector may any suitable material as long as the positive electrode current collector has electrical conductivity without causing an undesirable chemical change in a battery. Examples of materials for the positive electrode current collector include copper, stainless steel, aluminum, nickel, titanium, calcined carbon, copper or stainless steel each being surface-treated with carbon, nickel, titanium, or silver, and an aluminum-cadmium alloy. The positive electrode current collector may be processed to have surfaces that include fine bumps in order to enhance the binding force of the positive electrode active material to the positive electrode current collector. The positive electrode current collector may have any of various forms including films, sheets, foils, nets, porous structures, foams, and non-woven fabrics.

The positive electrode active material layer may include a positive electrode active material, a binder, and, optionally, a conducting agent. In some embodiments, the positive electrode active material may further include a compound represented by one of the following formulae:

LiₐA_{1-b}B′_{b}D′₂ (where 0.90≤a≤1 and 0≤b≤0.5);

LiₐE_{1-b}B′_{b}O_{2-c}D′_{c} (where 0.90≤a≤1, 0≤b≤0.5 and 0≤c≤0.05);

LiE_{2-b}B′_{b}O_{4-c}D′_{c} (where 0≤b≤0.5 and 0≤c≤0.05);

LiₐNi_{1-b-c}Co_{b}B′_{c}D′_{c} (where 0.90≤a≤1, 0≤b≤0.5, 0≤c≤0.05, and 0<α≤2);

LiₐNi_{1-b-c}Co_{b}B′_{c}O₂₋ₐF′_{α} (where 0.90≤a≤1, 0≤b≤0.5, 0≤c≤0.05, and 0<α≤2);

LiₐNi_{1-b-c}Co_{b}B′_{c}O_{2-α}F′₂ (where 0.90≤a≤1, 0≤b≤0.5, 0≤c≤0.05, and 0<α<2);

LiₐNi_{1-b-c}Mn_{b}B′_{c}D′_{α} (where 0.90≤a≤1, 0≤b≤0.5, 0≤c≤0.05, and 0<α≤2);

LiₐNi_{1-b-c}Mn_{b}B′_{c}O_{2-α}F′_{α} (where 0.90≤a≤1, 0≤b≤0.5, 0≤c≤0.05, and 0<α<2);

LiₐNi_{1-b-c}Mn_{b}B′_{c}O₂₋ₐF′₂ (where 0.90≤a≤1, 0≤b≤0.5, 0≤c≤0.05, and 0<α<2);

LiₐNi_{b}E_{c}G_{d}O₂ (where 0.90≤a≤1, ≤b≤0.9, 0≤c≤0.5, and 0.001≤d≤0.1.);

LiₐNi_{b}Co_{c}Mn_{d}GₑO₂ (where 0.90≤a≤1, 0≤b≤0.9, 0≤c≤0.5, 0≤d≤0.5, and 0.001≤e≤0.1.);

LiNiG_{b}O₂ (where 0.90≤a≤1 and 0.001≤b≤0.1.);

LiₐCoG_{b}O₂ (where 0.90≤a≤1 and 0.001≤b≤0.1.);

LiₐMn₂G_{b}O₂ (where 0.90≤a≤1 and 0.001≤b≤0.1.);

LiₐMn₂G_{b}O₄ (where 0.90≤a≤1 and 0.001≤b≤0.1.);

QO₂; QS₂; LiQS₂; V₂O₅; LiV₂O₅; LiI′O₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above, A may be nickel (Ni), cobalt (Co), manganese (Mn), or combinations thereof; B may be aluminum (Al), nickel (Ni), cobalt (Co), manganese (Mn), chromium (Cr), iron (Fe), magnesium (Mg), strontium (Sr), vanadium (V), a rare earth element, or combinations thereof; D may be oxygen (O), fluorine (F), sulfur (S), phosphorus (P), or combinations thereof; E may be cobalt (Co), manganese (Mn), or combinations thereof; F′ may be fluorine (F), sulfur (S), phosphorus (P), or combinations thereof; G may be aluminum (Al), chromium (Cr), manganese (Mn), iron (Fe), magnesium (Mg), lanthanum (La), cerium (Ce), strontium (Sr), vanadium (V), or combinations thereof; Q may be titanium (Ti), molybdenum (Mo), manganese (Mn), or combinations thereof; I′ may be chromium (Cr), vanadium (V), iron (Fe), scandium (Sc), yttrium (Y), or combinations thereof; and J may be vanadium (V), chromium (Cr), manganese (Mn), cobalt (Co), nickel (Ni), copper (Cu), or combinations thereof.

In some embodiments, LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5 and 0≤y≤0.5), and FePO₄ may be used as the positive electrode active material.

The compounds listed above as cathode active materials may have a surface coating layer (e.g. a “coating layer”). In one embodiment, a mixture of the compound that is selected from the compounds listed above and a compound without a coating layer may be used. In some embodiments, the coating layer may include a coating element compound selected from oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. The coating layer may be formed using any method (for example, a spray coating method or a dipping method) that does not adversely affect the physical properties of cathode active material when a compound of the coating element is used.

The binder adheres the positive electrode active material particles to each other and adheres the positive electrode active material to the positive electrode current collector. Examples of the binder include polyvinyl alcohol, carboxymethylcellulose, hydroxypropylcellulose, diacetylcellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, and nylon.

The conducting agent is used to give conductivity to an electrode and thus may be any electrically conductive material that does not cause a chemical change in a battery thus fabricated. Examples of the conducting agent include natural graphite, artificial graphite, carbon black, acetylene black, and Ketjen black, carbon fibers, metal powder or metal fibers of copper, nickel, aluminum, or silver, and a conducting material such as a polyphenylene derivative that may be used alone or as a mixture of more than one type.

The negative electrode 22 includes a negative electrode active material layer formed on the negative electrode current collector. The negative electrode current collector may be, for example, prepared to have a thickness in a range of about 3 μm to about 500 μm. The negative electrode current collector may include any suitable material as long as the negative electrode current collector has electrical conductivity without causing an undesirable chemical change in a battery. Examples of the negative electrode current collector include copper, stainless steel, aluminum, nickel, titanium, sintered carbon, copper or stainless steel each being surface-treated with carbon, nickel, titanium, or silver, and an aluminum-cadmium alloy. The negative electrode current collector may be processed to have surfaces with fine bumps in order to enhance a binding force of the negative electrode active material to the negative electrode current collector. The negative electrode current collector may have various forms including films, sheets, foils, nets, porous structures, foams, non-woven fabrics, or another form.

The negative electrode active material layer may include a negative electrode active material, a binder, and, optionally, a conducting agent. Examples of the negative electrode active material may include lithium metal, a metal that is alloyable with lithium, a transition metal oxide, a compound capable of doping and de-doping lithium, and a compound capable of reversibly intercalating and deintercalating lithium ions, and at least two selected therefrom may be used as a mixture or a combination.

Examples of the lithium metal alloy may include an alloy of lithium and a metal such as Na, K, Rb, Cs, Fr, Be, Mg, Ca, Sr, Si, Sb, Pb, In, Zn, Ba, Ra, Ge, Al, and Sn.

Examples of the transition metal oxide include a tungsten oxide, a molybdenum oxide, a titanium oxide, a lithium titanium oxide, a vanadium oxide, and a lithium vanadium oxide.

Examples of the compound capable of doping and de-doping lithium may include Si; SiOₓ (where 0<x<2); a Si—Y alloy (where Y is an alkali metal, an alkali earth metal, a Group 13 element, a Group 14 element, a Group 15 element, a Group 16 element, a transition metal, a rare-earth element, or a combination thereof, but not Si); Sn; SnO₂; and a Sn—Y alloy (where Y is an alkali metal, an alkali earth metal, a Group 13 element, a Group 14 element, a Group 15 element, a Group 16 element, a transition metal, a rare-earth element, or a combination thereof, but not Sn). Also, at least one of the materials capable of doping and de-doping lithium may be used as a mixture with SiO₂. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The compound capable of reversibly intercalating and deintercalating lithium ions may be any one of various carbon-based materials. Examples of the compound capable of reversibly intercalating and deintercalating lithium ions include crystalline carbon, amorphous carbon, and a mixture thereof. Examples of the crystalline carbon may include natural graphite and artificial graphite, each of which has an amorphous shape, a plate shape, a flake shape, a spherical shape, a fiber shape, or another shape. Examples of the amorphous carbon include soft carbon (low-temperature calcined carbon), hard carbon, meso-phase pitch carbide, and calcined cokes.

Examples of the crystalline carbon may include natural graphite, artificial graphite, expanded graphite, graphene, fullerene soot, carbon nanotubes, and carbon fibers. Examples of the amorphous carbon may include soft carbon, hard carbon, mesophase pitch carbide, and calcined cokes. The carbonaceous negative electrode active material may be used in a spherical shape, a plate shape, a fiber shape, a tube shape, in the form of powder, or another form or shape.

The binder adheres the negative electrode active material particles to each other and adheres the negative electrode active material to the negative electrode current collector. Examples of the binder include polyvinyl alcohol, carboxymethylcellulose, hydroxypropylcellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The conducting agent is used to give conductivity to an electrode and thus may be an electrically conductive material that does not cause a chemical change in a battery thus fabricated. Examples of the conducting agent include natural graphite, artificial graphite, carbon black, acetylene black, and Ketjen black, carbon fibers, metal powder or metal fibers of copper, nickel, aluminum, or silver, or a conducting material such as a polyphenylene derivative may be used alone or as a mixture of more than one type.

Each of the positive electrode 23 and the negative electrode 22 may be prepared by mixing an active material, a conducting agent, and a binder in a solvent to form an active material composition and coating the composition on a current collector. Examples of the solvent include but are not limited to N-methyl-pyrrolidone (NMP), acetone, and water.

A coating layer including the polymer particles on an active material layer surface is formed on at least one of the positive electrode 23 and the negative electrode 22. As described above, the coating layer may be, for example, coated on the electrode using a suspension including the polymer particles in an aqueous solvent. Various methods may be used to coat the suspension on an active material layer surface. Examples include flow coating, spin coating, dip coating, and bar coating. After coating the suspension on the active material layer surface, a coating layer may be formed in which the polymer particles are stacked at a high density through a high-temperature compressing process.

The positive electrode 23 and the negative electrode 22 are separated by the separator 24. After assembling the positive electrode 23 and the negative electrode 22 to face each other with the separator 24 in the middle, a lithium salt-containing non-aqueous electrolyte may be injected therebetween. The separator 24 may include, for example, a material that has low resistance to migration of ions of an electrolyte and has an excellent electrolytic solution-retaining capability. The separator 24 may be a single layer or a multi-layer and, for example, may include glass fiber, polyester, Teflon, polyethylene, polypropylene, polytetrafluoroethylene (PTFE), or a combination thereof, each of which may be non-woven or woven. The separator 24 may have a pore diameter in a predetermined range (e.g., about 0.01 μm to about 10 μm) and a predetermined thickness, e.g., in a range of about 3 μm to about 100 μm. The pore diameter and/or thickness of the separator 24 may be different in other embodiments.

A lithium salt-containing non-aqueous electrolyte includes a non-aqueous electrolyte and a lithium salt. Examples of the non-aqueous electrolyte include a non-aqueous electrolyte solution, an organic solid electrolyte, and an inorganic solid electrolyte.

The non-aqueous electrolyte solution may be an aprotic organic solvent. Examples of the aprotic organic solvent include N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, methylformamide, methyl acetate, phosphoric acid triester, trimethoxymethane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte include polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Examples of the inorganic solid electrolyte include nitrides, halides, and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt may be any lithium salt that is soluble in the lithium salt-containing non-aqueous electrolyte. Examples include at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carbonate, lithium tetraphenyl borate, and lithium imide.

The lithium battery may be suitable for devices requiring high capacity, high output, and high temperature driving. Examples of such devices include electric vehicles, mobile phones, and portable computers. The lithium battery may be used in combination with an internal combustion engine, fuel cells, and super capacitors, and may be suitable for use in hybrid vehicles. In addition, the lithium battery may be used for other applications requiring high output, high voltage, and high temperature driving. A number of example embodiments will now be discussed, along with several comparative examples.

### Example 1

(1) Preparation of Positive Electrode

A positive electrode active material powder having a composition of LiCoO₂ and a carbon conducting agent (Super-P, available from Timcal Ltd.) were homogenously mixed at a weight ratio of 90:5, and a PVdF binder solution was added thereto to mix the active material, the carbon conducting agent, and the binder at a weight ratio of 90:5:5. Then, a solvent, N-methylpyrrolidone, was added to control viscosity so that a solid content was 60 wt %, and thus a slurry was prepared. The active material slurry was coated on an aluminum foil having a thickness of 15 μm, and the result was dried and roll-pressed to prepare a positive electrode having a thickness of 52 μm. The mixture density of the positive electrode plate was 5.1 g/cc.

(2) Aqueous Coating of Positive Electrode

In order to form a coating layer on a surface of the positive electrode, 7.7 mg of polyvinylidene fluoride-hexafluoropropylene (PVDF-HFP) particles (RC-10246; an average particle diameter of ˜30 nm, available from Arkema) were dispersed in 100 ml of water to prepare an aqueous suspension having a viscosity of 300 cps. Next, the aqueous suspension was coated on a surface of the positive electrode at a thickness of 4 μm, and then primary 100° C. convection drying and secondary 110° C. convection drying were performed. The total drying time was 15 minutes.

(3) Preparation of Negative Electrode

A graphite powder as a negative electrode active material and a PVdF binder were mixed at a weight ratio of 1:1 to prepare a mixture. In order to control a viscosity of the mixture, N-methylpyrrolidone was added to the mixture so that a solid content of the mixture was 60 wt %, and thus a negative electrode active material slurry was prepared. The slurry thus prepared was coated on a copper foil current collector having a thickness of 10 μm, and the resultant was dried and roll-pressed to prepare a negative electrode.

(4) Preparation of Coin Full Cell

A separator (STAR20, available from Asahi) of a polyethylene material having a thickness of 20 μm was inserted between the positive electrode and the negative electrode, and an electrolyte solution was injected thereto. The electrolyte solution was prepared by dissolving LiPF₆ in a solvent mixture including ethylene carbonate (EC), ethylmethyl carbonate (EMC), and diethyl carbonate (DEC) (where a volume ratio of EC:EMC:DEC=3:3:4) so that a concentration of LiPF₆ was 1.10 M.

The positive electrode, the negative electrode, and the separator were high-temperature compressed at a temperature of 100° C. and a pressure of 500 kgf for 5 minutes, and the resultant was cooled to 30° C., thereby completing the manufacture of a CR2032 type coin full cell. The thickness of the coating layer after the high-temperature compressing was 0.032 nm.

### Example 2

A coin full cell was manufactured in the same manner as in Example 1, except that an organic coating layer was further formed on a surface of the negative electrode prepared in Example 1.

To form an organic coating layer on a surface of the negative electrode, 7.7 mg of PVDF-HFP particles (KF9300; an average particle diameter of ˜30 nm, available from Kureha) were dissolved in 350 ml of NMP, and thus an organic coating layer solution was prepared. Subsequently, the organic coating layer solution was coated on a surface of the negative electrode prepared in Example 1 by using a doctor blade, and then primary 100° C. convection drying and secondary 110° C. convection drying were performed thereon. The total drying time was 15 minutes.

### Comparative Example 1

A coin full cell was manufactured in the same manner as in Example 1, except that the aqueous suspension in Example 1 was not coated on a surface of the positive electrode but was coated on a surface of the separator facing the positive electrode.

### Comparative Example 2

A coin full cell was manufactured in the same manner as in Example 1, except that organic coating instead of the aqueous coating was performed on a surface of the positive electrode.

To form an organic coating layer on a surface of the positive electrode, 7.7 mg of PVDF-HFP particles (KF9300; an average particle diameter of ˜30 nm, available from Kureha) were dissolved in 350 ml of NMP, and thus an organic coating layer solution was prepared. Subsequently, the organic coating layer solution was coated on a surface of the positive electrode prepared in Example 1 by using a doctor blade, and then primary 100° C. convection drying and secondary 110° C. convection drying were performed thereon. The total drying time was 15 minutes.

### Comparative Example 3

A coin full cell was manufactured in the same manner as in Example 1, except that the aqueous coating was not performed on a surface of the positive electrode prepared in Example 1.

### Evaluation Example 1

Observation on Coating State of Positive Electrode Surface

In order to observe a coating state of the aqueous coating and organic coating on the positive electrode surface, a coating layer was formed on a surface of the positive electrode prepared in Example 1 and Comparative Example 2. Then, surface and cross-section states of the positive electrode were observed using a field emission scanning electron microscope (FE-SEM).

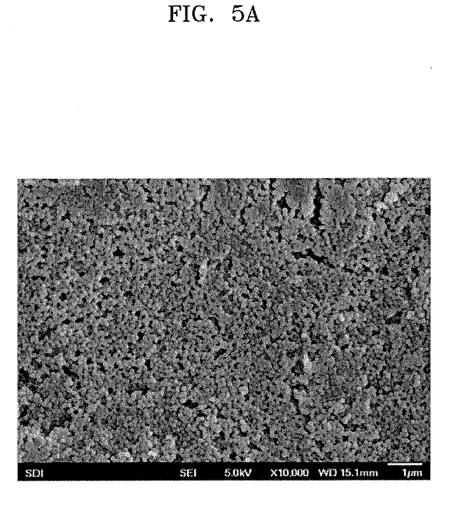

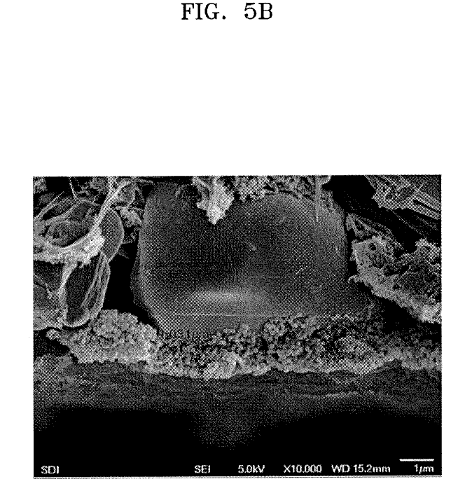

FIG. 5A illustrates an SEM image of a surface of the coating layer of Example 1. As shown in FIG. 5A, in the case of the aqueous coating, the PVdF-HFP particles remained the same and were densely packed.

FIG. 5B illustrates an SEM image of a part where the positive electrode of Example 1 and the coating layer contact each other. As shown in FIG. 5B, the PVdF-HFP particles are stacked and thus coated on a surface of the positive electrode at a thickness of about 1 μm, and the PVdF-HFP particles surround the positive electrode active material existing on a surface of the positive electrode and fill space between the positive electrode active material particles.

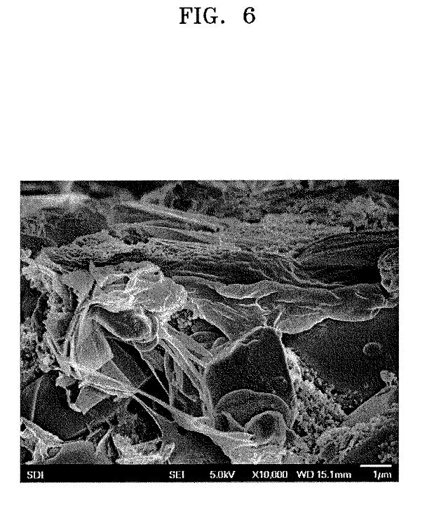

FIG. 6 illustrates an SEM image of a part where the positive electrode of Comparative Example 2 and the coating layer contact each other. As shown in FIG. 6, in the case of the organic coating, the PVdF-HFP particles are completely dissolved, and thus a thin layer that is assumed to be PVdF existed. In the case of Comparative Example 2, measuring the thickness of the coating layer was difficult due to its morphology characteristics.

### Evaluation Example 2

Evaluation of Coating Layer Density

The density of a coating layer coated on a surface of the positive electrode in Example 1 was calculated as 480.5 mg/cm³. The density of the coating layer may be further improved when a different coating method is used.

In the case of Comparative Example 2, the thickness of the coating layer could not be accurately measured. Thus, density of the coating layer could not be calculated.

### Evaluation Example 3

Evaluation of Electrostatic Generation

In order to measure an electrostatic generation amount of the coating layer used in Example 1 and Comparative Example 1, an electrostatic measurement device (775PVS) available from Ion System was used to measure an electrostatic charge. The results are shown in Table 1. An electrostatic charge unit was kV/in.

TABLE 1

| | Electrostatic charge (kV/in) |
|---|---|
| Example 1 | 0.02 |
| Comparative Example 1 | 2.78 |

As shown in Table 1, when the PVdF-HFP particles were coated on the positive electrode surface, electrostatic generation reduced to about 1/140 compared to when the particles were coated on the separator. It was confirmed that forming a PVdF-HFP particle coating layer on an electrode surface, not a separator, was very effective in suppressing electrostatic generation.

### Evaluation Example 4

Evaluation of Adhesive Strength

In order to confirm differences between adhesive strengths of the aqueous coating and the organic coating, the adhesive strengths between a separator and a positive electrode in each of the coin full cells of Example 1 and Comparative Example 2 were evaluated as follows.

The separator and the positive electrode of each of Example 1 and Comparative Example 2 contacting each other were cut into a size of 10 mm (MD direction)×50 mm (TD direction). Then, the separator and the positive electrode were attached to tape (scotch, available from 3M) except about 5 mm from each end thereof. Subsequently, one of the two ends that were not attached to tape was fixed on an upper action grip of the Universal test machine (UTM, Mode3343, available from Instron). The tape of the other end was fixed on a lower action grip to measure a force at which the separator and the positive electrode were detached. This force was used as an adhesive strength. The results of adhesive strength evaluation are shown in Table 2.

TABLE 2

| | Adhesive strength (N/mm) |
|---|---|
| Example 1 | 0.027 |
| Comparative Example 2 | 0.004 |

As shown in Table 2, adhesive strength was significantly improved when the aqueous coating using an aqueous suspension, in which PVdF-HFP particles were dispersed, was used, compared to when the organic coating using an organic coating solution in which PVdF-HFP particles were completely dissolved in an organic solvent.

### Evaluation Example 5: Evaluation of Stiffness

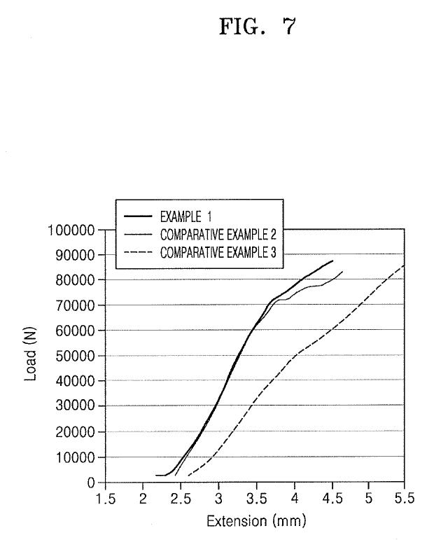

In order to compare stiffnesses in cases of the aqueous coating, the organic coating, and non-coating were used, the coated positive electrodes prepared in Example 1 and Comparative Example 2 and the non-coated positive electrode prepared in Comparative Example 3 were each cut into a size of 10 mm×20 mm. Using a three point bending tester (manufactured in-house), each of the positive electrodes was placed between two points spaced 10 mm apart and a center of the positive electrodes was pressed toward the other point to perform a bending test. A measuring speed was 100 mm/min, and the results of the measurement of the stiffness values are shown in FIG. 7.

As shown in FIG. 7, the aqueous coating and the organic coating improved stiffnesses of the positive electrodes compared to that of the non-coated positive electrode. Although differences in stiffnesses of the positive electrodes of the aqueous coating and the organic coating was not significant, the aqueous coating was a little better in terms of the stiffness of the positive electrode.

### Evaluation Example 6: Evaluation of Change in Discharge Capacity Per Cycle and Thickness of Positive Electrode

Charging/discharging characteristics of the lithium batteries prepared in Examples 1 and 2 and Comparative Example 3 were evaluated as follows. At room temperature (25° C.), each of the batteries was charged at a constant current of 0.5 C rate until a voltage was 4.35 V (vs. Li). Then, while maintaining the voltage at 4.35 V in a constant voltage mode, the current was cut-off at a current of 0.05 C rate. Next, the batteries were each discharged at a constant current of 0.5 C rate until a voltage was 3.0 V (vs. Li) (a formation process, 1^{st} cycle).

At 25° C., each of the lithium batteries that underwent the formation process were charged at a constant current of 0.5 C rate until a voltage was 4.35 V (vs. Li). Then, while maintaining the voltage at 4.35 V in a constant voltage mode, the current was cut-off at a current of 0.05 C rate. Next, the batteries were each discharged at a constant current of 0.05 C rate until a voltage was 3.0 V (vs. Li), and this cycle was repeated up to the 400^{th} cycle.

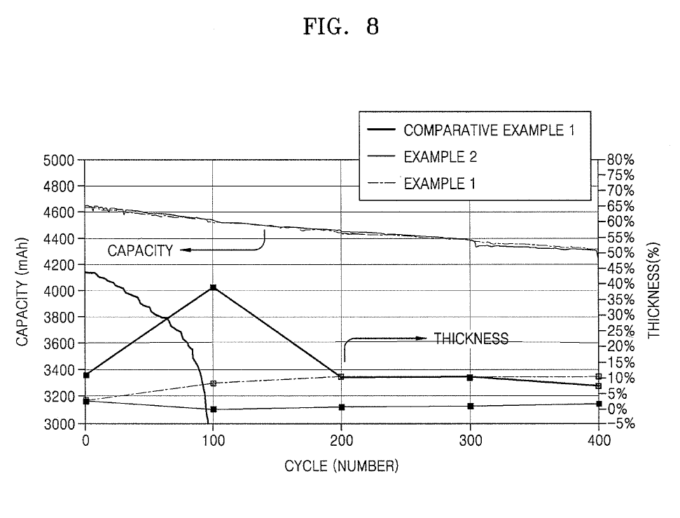

FIG. 8 illustrates discharge capacities per cycle. Thicknesses of the positive electrodes after the 100^{th}, 200^{th}, 300^{th}, and 400^{th} charging/discharging cycles were measured, and the results are also shown in FIG. 8.

As shown in FIG. 8, discharge capacities per cycle in all the lithium batteries of Examples 1 and 2 and Comparative Example 3 appeared almost similar to each other, but the thickness change decreased in the order of the non-coating case, the coating only performed on the positive electrode, and the coating performed on both the positive electrode and the negative electrode as the number of cycles increased. This means that forming a coating layer may be preferable in suppressing thickness change in terms of an adhesive strength retention rate while cycles proceed.

In accordance with one or more of the aforementioned embodiments, an electrode for a lithium battery have improved adhesive strength with a separator. As a result, battery performance and stability may be improved.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. An electrode for a lithium battery, the electrode comprising:
an active material layer; and
a coating layer on at least one surface of the active material layer,
wherein the coating layer includes polymer particles.

2. The electrode as claimed in claim 1, wherein the coating layer is filled with the polymer particles.

3. The electrode as claimed in claim 1, wherein the polymer particles have an average particle diameter in a range of about 1 nm to about 10 μm.

4. The electrode as claimed in claim 1, wherein the polymer particles include a polymer that is soluble in an organic medium and forms a suspension in an aqueous medium.

5. The electrode as claimed in claim 1, wherein the polymer particles include polyvinylidene fluoride (PVdF), polyvinylidene fluoride-hexafluoropropylene (PVdF-co-HFP), polyvinylidene fluoride-trichlorethylene, polyvinylpyrrolidone, polyethylene oxide (PEO), polyacrylonitrile (PAN), polyamide (PI), polyamic acid (PAA), polyamidimide (PAI), aramid, polyvinylacetate (PVA), an ethylenevinylacetate copolymer, an ethylene ethylacrylate copolymer, polymethylmethacrylate (PMMA), polyvinylether (PVE), carboxymethylcellulose, polyacrylic acid, polyvinyl alcohol, or a combination thereof.

6. The electrode as claimed in claim 5, wherein the polymer particles include polyvinylidene fluoride (PVdF), polyvinylidene fluoride-hexafluoropropylene (PVdF-co-HFP), polyvinylidene fluoride-trichlorethylene, or a combination thereof.

7. The electrode as claimed in claim 1, wherein the coating layer has a density in a range of about 200 mg/cc to about 2000 mg/cc.

8. The electrode as claimed in claim 1, wherein the coating layer has a thickness in a range of about 0.1 μm to about 10 μm.

9. The electrode as claimed in claim 1, wherein the active material layer has a thickness in a range of about 1 μm to about 300 μm.

10. The electrode as claimed in claim 1, wherein the electrode exhibits an electrostatic charge of lower than 0.1 kV/in.

11. A lithium battery, comprising:
a positive electrode;
a negative electrode; and
a separator between the positive electrode and the negative electrode,
wherein at least one of the positive electrode and the negative electrode includes the electrode as claimed in claim 1.

12. The lithium battery as claimed in claim 11, wherein at least the positive electrode is an electrode for a lithium battery.

13. The lithium battery as claimed in claim 11, wherein the electrode is arranged such that the coating layer contacts the separator.

14. A method for manufacturing a lithium battery, the method comprising:
preparing a suspension including polymer particles in an aqueous medium;
applying the suspension on at least one of a positive electrode active material layer and a negative electrode active material layer; and
disposing a separator between the positive electrode active material layer and the negative electrode active material layer and high-temperature compressing the separator.

15. The method as claimed in claim 14, wherein the polymer particles include polyvinylidene fluoride (PVdF), polyvinylidene fluoride-hexafluoropropylene (PVdF-co-HFP), polyvinylidene fluoride-trichlorethylene, polyvinylpyrrolidone, polyethylene oxide (PEO), polyacrylonitrile (PAN), polyamide (PI), polyamic acid (PAA), polyamidimide (PAI), aramid, polyvinylacetate (PVA), an ethylene vinylacetate copolymer, an ethylene ethylacrylate copolymer, polymethylmethacrylate (PMMA), polyvinylether (PVE), carboxymethylcellulose, polyacrylic acid, polyvinyl alcohol, or a combination thereof.

16. The method as claimed in claim 15, wherein the polymer particles include polyvinylidene fluoride (PVdF), polyvinylidene fluoride-hexafluoropropylene (PVdF-co-HFP), polyvinylidene fluoride-trichlorethylene, or a combination thereof.

17. The method as claimed in claim 14, wherein the polymer particles have an average particle diameter in a range of about 1 nm to about 10 μm.

18. The method as claimed in claim 14, wherein the suspension has a viscosity in a range of about 10 cps to about 1000 cps.

19. The method as claimed in claim 14, wherein the high-temperature compressing is performed at a temperature in a range of about 70° C. to about 150° C.

20. The method as claimed in claim 14, wherein the high-temperature compressing is performed at a pressure in a range of about 300 kgf to about 1000 kgf.
